(19) United States
(12) Patent Application Publication
(10) Pub. No.: US 2025/0313049 A1
(43) Pub. Date: Oct. 9, 2025

(54) SELF-LATCHING AUTO-RESETTING TRAILER COUPLER

(71) Applicant: B & W Custom Truck Beds, Inc., Humboldt, KS (US)

(72) Inventor: Travis M. McCall, Humboldt, KS (US)

(73) Assignee: B & W Custom Truck Beds, Inc., Humboldt, KS (US)

(21) Appl. No.: 19/172,547

(22) Filed: Apr. 7, 2025

Related U.S. Application Data
(60) Provisional application No. 63/631,106, filed on Apr. 8, 2024.

(51) Int. Cl. B60D 1/06; B60D 1/48

(52) U.S. Cl. CPC B60D 1/065; B60D 1/488

(57) ABSTRACT

A coupler for connecting a trailer to a towing vehicle, including a housing and a pin. The housing rotatably supports the pin and includes a ball receiver formed therein for receiving a head of a hitch ball. The pin extends in an axis of rotation transverse to a vertical axis of the ball receiver and is rotatable between a latched orientation and an unlatched orientation. The pin is extendable below the ball receiver and includes a contact surface longitudinally oriented thereon. A lever is pivotable between a first position and a second position and projects outward from the pin, and an extension spring is linked to the pin, with the extension spring biasing the lever to the first position when the pin is rotated to the latched orientation, and the extension spring biasing the lever to the second position when the pin is rotated to the latched orientation.

### CROSS-REFERENCE TO RELATED APPLICATIONS

This application claims the benefit of U.S. Provisional Patent Application Ser. No. 63/631,106, entitled Self Latching Automatic Triggering Gooseneck Coupler Assembly, filed Apr. 8, 2024, the disclosure of which is incorporated herein in its entirety by reference.

### FIELD OF THE INVENTION

This invention relates to couplers for connecting trailers to towing vehicles, and in particular to a self-latching coupler that automatically resets.

### BACKGROUND

Various types of trailer couplers used to connect a trailer to a towing vehicle are well-known in the art. Commonly, a coupler mounted to a tongue of a trailer clamps to a hitch ball on a towing vehicle. Variations of this system have been used on both bumper-pull trailers and “gooseneck” trailers which connect to a hitch ball located in the bed of a truck.

The tongue of the trailer must be properly positioned relative to the towing vehicle before the coupler can couple to the hitch ball. For example, in gooseneck applications, a user may have to climb into the bed of the truck to operate the coupler so that it couples to the hitch ball after lowering the tongue of the trailer into the bed of the truck. Because it can be difficult to properly position the coupler for coupling to the hitch ball and it may be unclear whether the coupler is properly positioned, a user may have to climb into and out of the bed of the truck multiple times to couple the coupler to the hitch ball, resulting in lost time and user frustration.

In attempts to prevent such issues, prior art trailer couplers have often included assemblies that automatically couple to a hitch ball on a towing vehicle when the tongue of the trailer is properly positioned thereon. Such assemblies utilize a shaft that is laterally moveable or rotatable between an open position and a closed position. Compression springs or torsion springs are typically employed to bias the shaft to the closed position, and the shaft is displaced to the open position by the hitch ball as it moves into the coupler. When the hitch ball is sufficiently situated within the coupler, the springs bias the shaft back to the closed position, thereby automatically coupling with the hitch ball.

A problem with couplers utilizing compression springs or torsion springs, however, is that they can only bias the shaft toward one position. An actuator is required to overcome the unidirectional spring bias and move the shaft to the open position. Retention means are further required to hold the actuator against the spring bias such that the shaft remains in the open position when the hitch ball exits the coupler. The actuator and retention means may wear over time, causing premature failure of the coupler. Moreover, once the hitch ball is removed from the coupler, the actuator must be released from the retention means to return the shaft to the closed position and reset the automatic clamping feature of the coupler. Releasing the actuator is typically a manual process that requires time and effort on behalf of the user.

What is needed is a trailer coupler having a latching mechanism that can be biased toward multiple positions. Such a coupler could automatically latch onto a hitch ball entering the coupler and could further automatically reset when the hitch ball exits the coupler.

### SUMMARY

Embodiments of the invention are defined by the claims below, not this summary. A high-level overview of various aspects of the invention is provided here to introduce a selection of concepts that are further described in the Detailed Description section below. This summary is not intended to be used in isolation to determine the scope of the claimed subject matter. In brief, this disclosure describes, among other things, a coupler that self-latches and automatically resets for connecting a trailer to a towing vehicle.

In one embodiment of the present invention, the coupler includes a housing having a ball receiver formed therein for receiving a head of the hitch ball and a pin extending in an axis of rotation transverse to a vertical axis of the ball receiver. The pin is rotatable between a latched orientation and an unlatched orientation, extendable below the ball receiver, and includes a contact surface formed longitudinally thereon, the contact surface forming a first edge and a second edge and configured to engage with the head of the hitch ball. A handle which is pivotable or otherwise adjustable between a first position and a second position is attached to and projects outward from the pin, and a bracket is connected to and rotatable in correspondence with the pin, with an extension spring connected at a first end thereof to the bracket and connected at a second end thereof to an anchor plate of the housing such that the extension spring achieves an over-center condition relative to the axis of rotation in which the pin extends. Upon rotation of the pin to the latched orientation, the first edge of the contact surface formed thereon extends below the ball receiver, and the bracket correspondingly rotates such that the first end of the extension spring extends above the axis of rotation of the pin. Upon rotation of the pin to the unlatched orientation, the second edge of the contact surface formed thereon extends below the ball receiver, and the bracket correspondingly rotates such that the first end of the extension spring extends below the axis of rotation of the pin. Pivoting of the handle to the first position rotates the pin to the latched orientation, and pivoting of the handle to the second position rotates the pin to the unlatched orientation. When the head of the hitch ball is received within the ball receiver, rotating the pin to the latched orientation advances the first edge of the contact surface and a circumferential edge of the pin below an equator of the head of the hitch ball, thereby preventing withdrawal of the head of the hitch ball from the ball receiver, and rotating the pin to the unlatched orientation advances the second edge of the contact surface and a recessed portion of the pin below the equator of the head of the hitch ball, thereby allowing withdrawal of the head of the hitch ball from the ball receiver.

### DESCRIPTION OF THE DRAWINGS

Illustrative embodiments of the invention are described in detail below with reference to the attached drawing figures, and wherein:

FIG. 1 is a perspective view of a coupler in accordance with an embodiment of the invention, viewed from above and to the right;

FIG. 2 is a bottom plan view of the coupler of FIG. 1;

FIG. 3 is a fragmentary, elevational section view of the coupler of FIG. 1, taken along line 3 of FIG. 2 and viewed from the right;

FIG. 4 is a fragmentary, side elevational view of the coupler of FIG. 1, viewed from the right;

FIG. 5 is a fragmentary, side elevational view of the coupler of FIG. 1, viewed from the left;

FIG. 6 is a top plan view of the coupler of FIG. 1;

FIG. 7 is a side elevational view of the coupler of FIG. 1 with a latch mechanism in a latched orientation, viewed from the right and depicted with a weld removed for clarity;

FIG. 8 is a side elevational view of the coupler of FIG. 1 with a latch mechanism in a latched orientation, viewed from the left and depicted with a weld removed for clarity;

FIG. 9 is a front elevational view of the coupler of FIG. 1 with a latch mechanism in a latched orientation, depicted with a weld removed for clarity;

FIG. 10 is an elevational section view of the coupler of FIG. 1 with a latch mechanism in a latched orientation, taken along line 10 of FIG. 9, viewed from the right, and depicted with a weld removed for clarity;

FIG. 11 is a side elevational view of the coupler of FIG. 1 as a latch mechanism moves from a released orientation to a latched orientation, viewed from the right and depicted with a weld removed from clarity;

FIG. 12 is a side elevational view of the coupler of FIG. 1 as a latch mechanism moves from a released orientation to a latched orientation, viewed from the left and depicted with a weld removed for clarity;

FIG. 13 is a front elevational view of the coupler of FIG. 1 as a latch mechanism moves from a released orientation to a latched orientation, depicted with a weld removed for clarity;

FIG. 14 is an elevational section view of the coupler of FIG. 1 as a latch mechanism moves from a released orientation to a latched orientation, taken along line 14 of FIG. 13, viewed from the right, and depicted with a weld removed for clarity;

FIG. 15 is a side elevational view of the coupler of FIG. 1 with a latch mechanism in an unlatched orientation, viewed from the right and depicted with a weld removed for clarity;

FIG. 16 is a side elevational view of the coupler of FIG. 1 with a latch mechanism in an unlatched orientation, viewed from the left and depicted with a weld removed for clarity;

FIG. 17 is a front elevational view of the coupler of FIG. 1 with a latch mechanism in an unlatched orientation, depicted with a weld removed for clarity;

FIG. 18 is an elevational section view of the coupler of FIG. 1 with a latch mechanism in an unlatched orientation, taken along line 18 of FIG. 17 and depicted with a weld removed for clarity;

FIG. 19 is a perspective view of an alternative embodiment of the coupler, viewed from above and to the right;

FIG. 20 is a bottom plan view of the coupler of FIG. 19;

FIG. 21 is a fragmentary, elevational section view of the coupler of FIG. 19, taken along line 21 of FIG. 20 and viewed from the right;

FIG. 22 is a fragmentary, side elevational view of the coupler of FIG. 19, viewed from the right;

FIG. 23 is a fragmentary, side elevational view of the coupler of FIG. 19, viewed from the left;

FIG. 24 is a top plan view of the coupler of FIG. 19;

FIG. 25 is a side elevational view of the coupler of FIG. 19 with a latch mechanism in a latched orientation, viewed from the right and depicted with a weld removed for clarity;

FIG. 26 is a side elevational view of the coupler of FIG. 19 with a latch mechanism in a latched orientation, viewed from the left and depicted with a weld removed for clarity;

FIG. 27 is a front elevational view of the coupler of FIG. 19 with a latch mechanism in a latched orientation, depicted with a weld removed for clarity;

FIG. 28 is an elevational section view of the coupler of FIG. 19 with a latch mechanism in a latched orientation, taken along line 28 of FIG. 27, viewed from the right, and depicted with a weld removed for clarity;

FIG. 29 is a side elevational view of the coupler of FIG. 19 as a latch mechanism moves from a released orientation to a latched orientation, viewed from the right and depicted with a weld removed from clarity;

FIG. 30 is a side elevational view of the coupler of FIG. 19 as a latch mechanism moves from a released orientation to a latched orientation, viewed from the left and depicted with a weld removed for clarity;

FIG. 31 is a front elevational view of the coupler of FIG. 19 as a latch mechanism moves from a released orientation to a latched orientation, depicted with a weld removed for clarity;

FIG. 32 is an elevational section view of the coupler of FIG. 19 as a latch mechanism moves from a released orientation to a latched orientation, taken along line 32 of FIG. 31, viewed from the right, and depicted with a weld removed for clarity;

FIG. 33 is a side elevational view of the coupler of FIG. 19 with a latch mechanism in an unlatched orientation, viewed from the right and depicted with a weld removed for clarity;

FIG. 34 is a side elevational view of the coupler of FIG. 19 with a latch mechanism in an unlatched orientation, viewed from the left and depicted with a weld removed for clarity;

FIG. 35 is a front elevational view of the coupler of FIG. 19 with a latch mechanism in an unlatched orientation, depicted with a weld removed for clarity;

FIG. 36 is an elevational section view of the coupler of FIG. 19 with a latch mechanism in an unlatched orientation, taken along line 36 of FIG. 35 and depicted with a weld removed for clarity.

FIG. 37 is a fragmentary, partially exploded, perspective view of the coupler of FIG. 19, viewed from below and to the right and depicted with a weld and a shroud removed for clarity.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The term “approximately” as used herein denotes deviations from the exact value by +/−10%, preferably by +/−5%, and/or deviations in the form of changes that are insignificant to function.

Certain terminology will be used in the following description for convenience in reference only and will not be limiting. For example, the words “upwardly,” “downwardly,” “above,” and “below” will refer to directions in the drawings to which reference is made. The words “inner,” “inwardly,” “outer,” and “outwardly” will refer to directions toward and away from, respectively, the geometric center of the embodiment being described and designated parts thereof. The words “connected,” “joined,” “adjoined,” “attached,” “secure,” or variations thereof will encompass parts, elements, or components that are both formed separately or joined together, as by welding or through a mechanical coupling, or parts, elements, or components that are integrally formed together. Said terminology will include the words specifically mentioned, derivatives thereof, and words of a similar import.

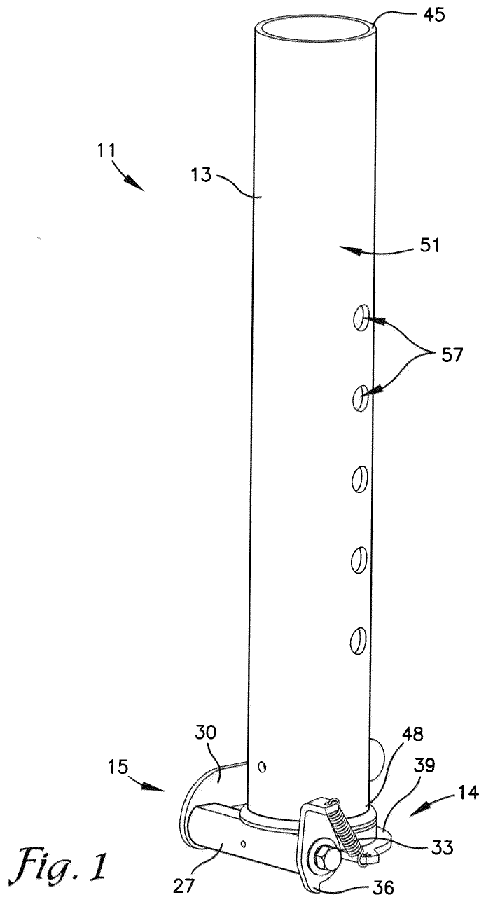

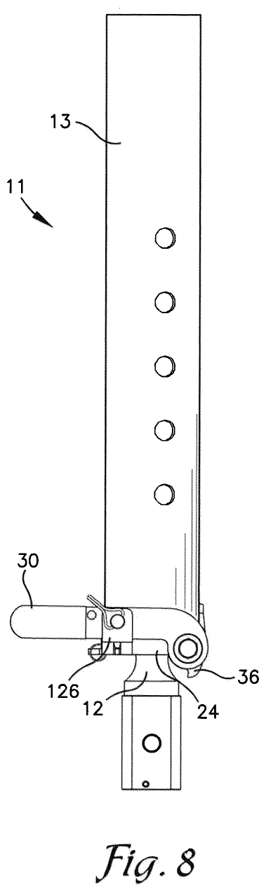

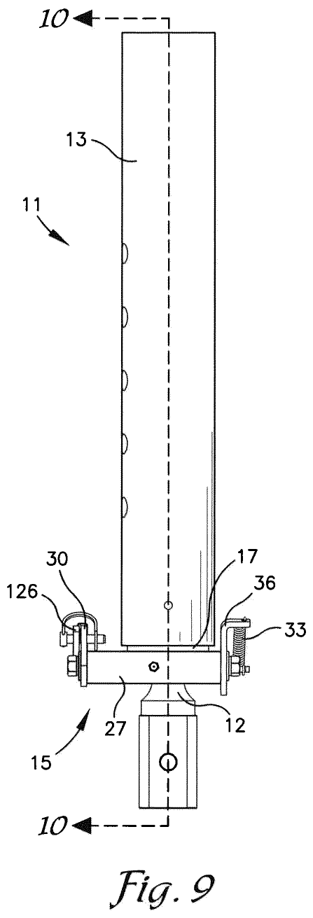

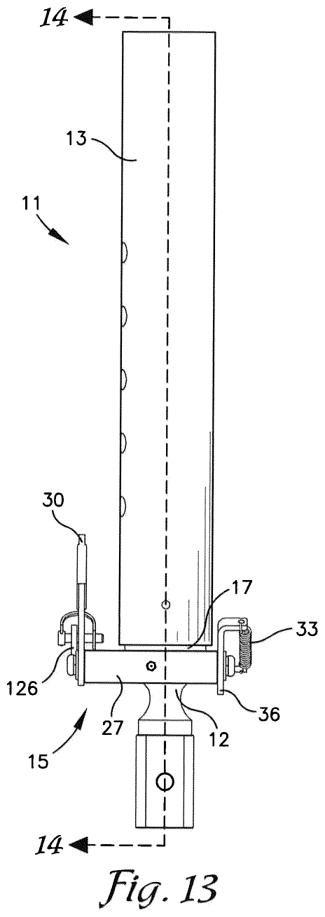

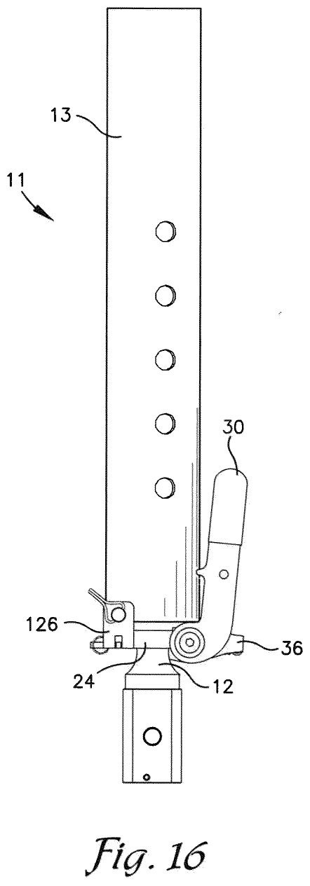

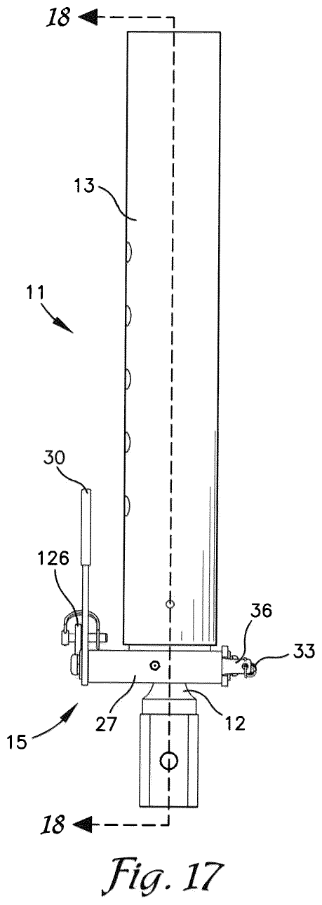

In the embodiment shown in FIGS. 1-18, a self-latching auto-resetting trailer coupler 11 is described in accordance with an embodiment of the invention. The coupler 11 is configured to be mounted on the tongue of a trailer (not shown) and is adapted to couple to a hitch ball 12 mounted to a towing vehicle (not shown) to connect the trailer to the towing vehicle. Raising and lowering means such as a trailer jack facilitate lowering or raising the coupler 11 onto or off of the hitch ball 12, which includes a generally spherical head and narrows below the head to a relatively thin neck. The embodiment of the coupler 11 shown and described herein is configured for use with a “gooseneck” type trailer, with the coupler 11 mounted to a post of the trailer which extends downward from an extended tongue such that the coupler 11 couples to a hitch ball 12 centrally mounted in the truck bed of a towing vehicle. It is to be understood, however, that the present invention can easily be adapted for use with other types of trailers such as bumper-pull trailers.

The coupler 11 includes a shank or neck 13 which is removably mountable to the tongue of a trailer and a housing 14 joined to an end of the shank 13 and configured to receive the head of the hitch ball 12. The head of the hitch ball 12 engages an adjustable latch mechanism 15 of the coupler 11 as the coupler 11 is coupled to and decoupled from the hitch ball 12, with the latch mechanism 15 adjustable between a latched orientation and an unlatched orientation. The latched orientation may also be referred to as a released orientation, as discussed hereafter. The housing 14 includes a receiver body or block 17 having a ball receiver 21 formed therein and to which a flange 24 and a pin chamber 27 are secured. The latch mechanism 15 includes a lever or handle 30 and a biasing element 33 operable for biasingly holding the latch mechanism 15 in the latched orientation or the unlatched orientation, with the lever 30 extending proximate one end of the pin chamber 27 and the biasing element 33 extending proximate the other end of the pin chamber 27 and between a bracket 36 and an anchor plate 39. A pin or rod 42 extends through and is rotatably supported by the pin chamber 27, with the lever 30 and the bracket 36 projecting out from opposite ends of the pin 42.

Referring to FIG. 1, the shank 13 extends from a first or upper end 45 to a second or lower end 48 along a central longitudinal axis and is adapted and configured to be removably mounted to the tongue of a trailer. The shank 13 includes at least one cylindrical wall 51 and is substantially hollow such that a space is formed therein. When the shank 13 is mounted to the tongue of a trailer, the tongue protrudes through the first end 45 and into the space, which is typically cylindrical but may comprise other geometries without departing from the scope of embodiments of the invention described herein. The shank 13 includes one or more alignment features 57 allowing the shank 13 to be mounted to the trailer tongue. When mounting the coupler 11 to a trailer tongue, one or more of the alignment features 57 are aligned with corresponding mounting features formed on the trailer tongue. In the embodiment shown and as best seen in FIG. 1, the alignment features 57 are a plurality of holes 57 formed in the cylindrical wall 51 and serially disposed along the length of the shank 13. In the embodiment shown, the alignment holes 57 are formed in diametrically disposed pairs with each pair of alignment holes 57 being coaxially aligned on a respective axis extending transverse to the shank 13.

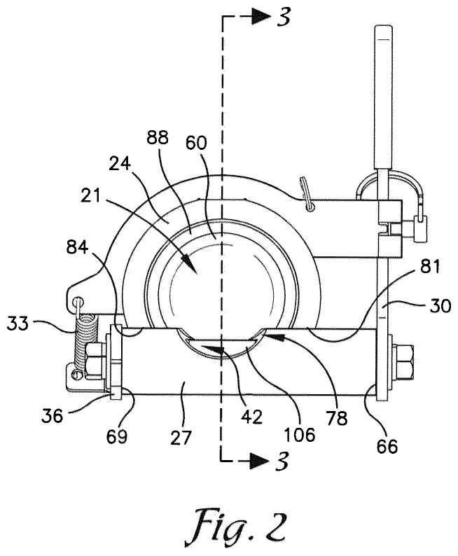

Referring to FIGS. 1 and 2, the housing 14 is disposed proximate the lower end 48 of the shank 13 with the receiver body 17 of the housing 14 protruding upward through the second end 48 and into the space formed within the shank 13. The ball receiver 21 formed in the receiver body 17 is generally hemispherical and oriented to face downward such that the head of the hitch ball 12 is received within the ball receiver 21 as the coupler 11 is lowered onto the hitch ball 12. In the embodiment shown, the ball receiver 21 is positioned relative to the shank 13 such that a central vertical axis extending upward through the ball receiver 21 extends coaxial with the central longitudinal axis along which the shank 13 extends. The ball receiver 21 is partially surrounded by a chamfer 60 which extends radially outward and downward from the ball receiver 21 to a lip 63 formed on the receiver body 17. The chamfer 60 is angled upwardly and inwardly to guide the head of the hitch ball 12 into ball receiver 21 as coupler 11 is lowered onto the hitch ball 12.

The receiver body 17 and the ball receiver 21 formed therein are intersected by the pin chamber 27 which is generally annular and, as best shown in FIG. 2, extends from a first or lever end 66 to a second or spring end 69 along a longitudinal axis extending transverse to the shank 13. The longitudinal axis along which the pin chamber 27 extends is spaced outward from the longitudinal axis along which the shank 13 extends and is positioned such that a portion of the pin chamber 27 extends below the ball receiver 21. As shown in FIG. 2, a generally parabolic cut-out 78 extends through the pin chamber 27 proximate the portion of the pin chamber 27 oriented below the ball receiver 21. The curvature of the cut-out 78 of the pin chamber 27 aligns with the curvature of ball receiver 21 such that when the coupler 11 is lowered onto or raised off of the hitch ball 12, the hitch ball 12 traverses the cut-out 78 and the pin chamber 27 does not impede or obstruct the head of the hitch ball 12 from moving into or out of the ball receiver 21.

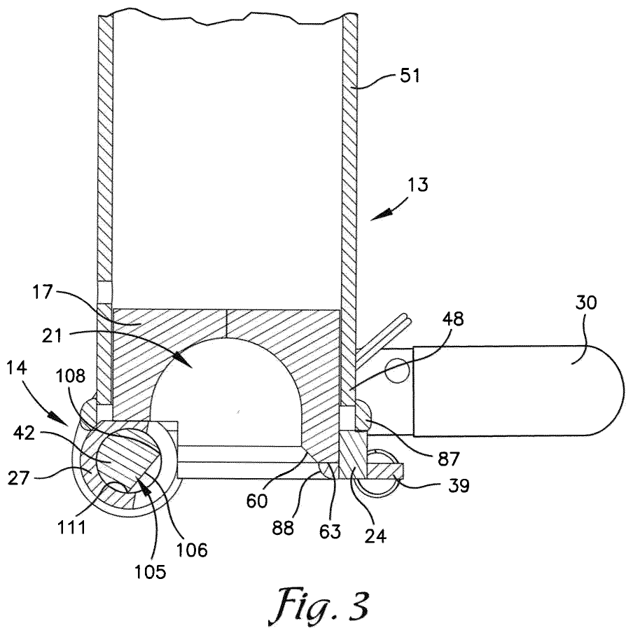

Referring to FIGS. 2 and 3, the flange 24 is generally arcuate and extends below the lower end 48 of the shank 13 and outwardly of the receiver body 17 such that the flange 24 surrounds and adjoins a portion of the receiver body 17. The flange 24 extends between first and second ends 81 and 84 which abut against the outer wall of the pin chamber 27. In an embodiment, the flange 24 extends to form an arc of approximately 210°. Though shown and described herein as generally arcuate, it is foreseen that the flange 24 may comprise a segment of some other geometry, such as a quadrilateral.

In the embodiment shown and as best seen in FIG. 3, the housing 14 is joined to the shank 13 by first and second welds or bonds 87 and 88. The first weld 87 attaches the flange 24 and the pin chamber 27 to the lower end 48 of the shank 13, and the second weld 88 attaches the flange 24 to the lip 63 of the receiver body 17 such that the second weld 88 is disposed radially outward and downward from the chamfer 60 and is configured to guide the head of the hitch ball 12 toward the chamfer 60 and into the ball receiver 21 as the coupler 11 is lowered onto the hitch ball 12. Though typically formed by welding, it is to be understood that the first and second bonds 87 and 88 may be formed by mechanically interconnecting or other means of attaching without departing from the scope of the embodiments of the invention described herein. It is also to be understood that the housing 14 including the receiver body 17 may be integrally formed with the shank 13 and such components integrally formed together may be deemed to be connected or joined together.

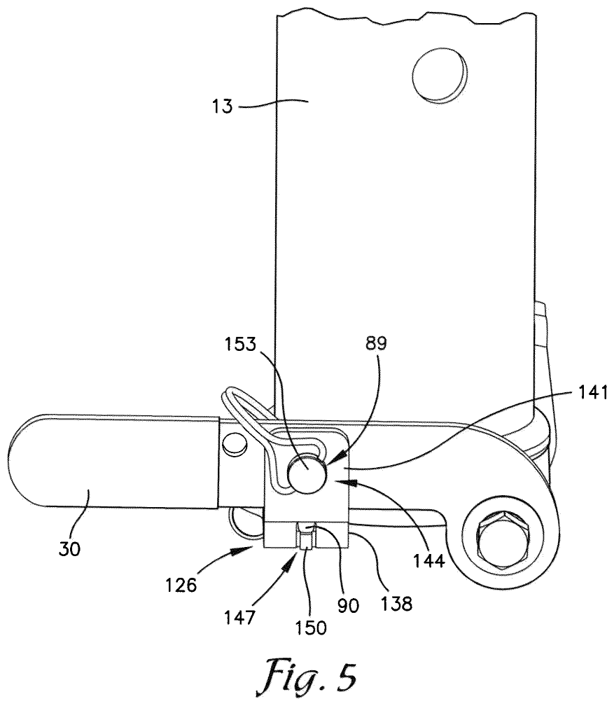

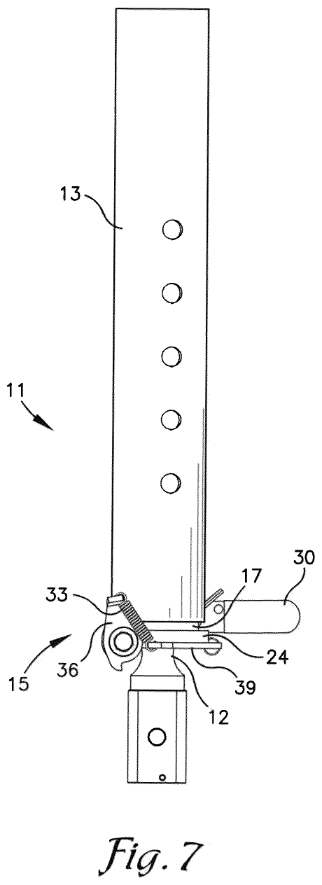

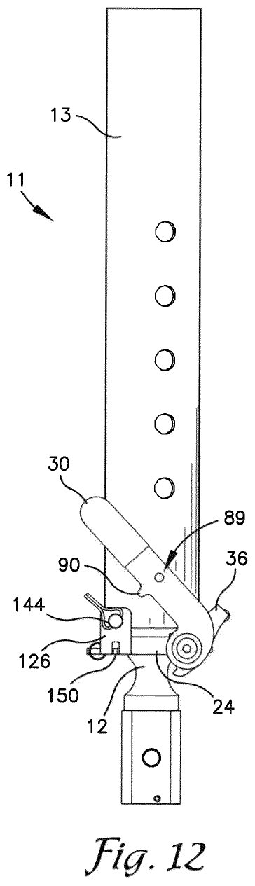

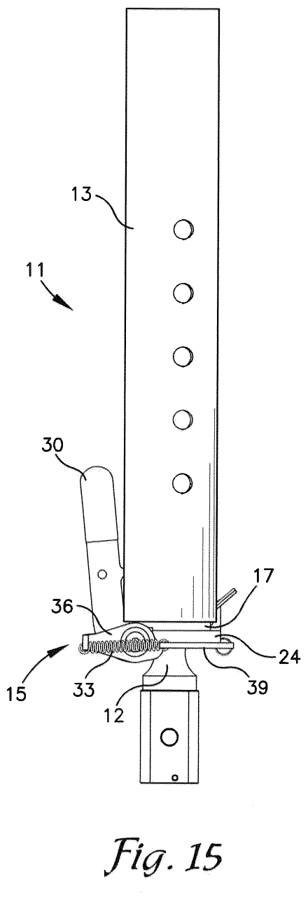

The handle 30 of the latch mechanism 15 is pivotable between a first or latched position (see FIGS. 7-10) wherein the handle 30 extends in a plane extending approximately transverse to a longitudinal axis of the shank 13 and approximately parallel to the truck bed of the towing vehicle and a second or unlatched position (see FIGS. 15-18) wherein the handle 30 extends in a plane extending approximately parallel to the longitudinal axis of the shank 13 and approximately transverse to the truck bed of the towing vehicle. As best shown in FIG. 12, a lock pin hole 89 is formed in the handle 30 proximate the longitudinal midpoint thereof. A nub 90 projects from a lower edge of the handle 30 such that the nub 90 projects downward when the handle 30 is pivoted to the first position as shown in FIG. 5. Although the handle 30 is shown and described herein as being a generally L-shaped or rectangular member, it is foreseen that the handle 30 may comprise other geometries or configurations. For example, it is foreseen that the lever 30 may take the form of a rounded knob or star-shaped handle 30 which is rotatable between a first position and a second position.

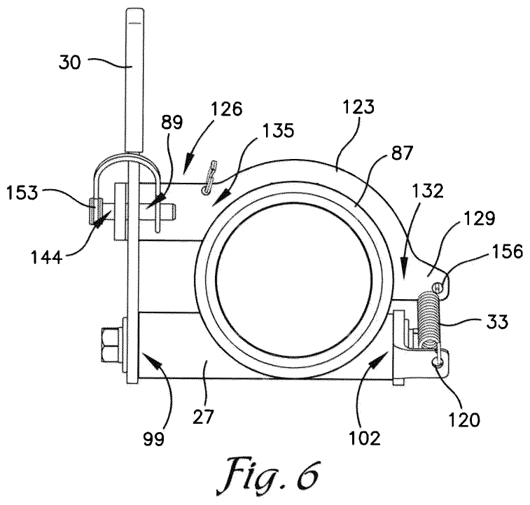

As best shown in FIGS. 2 and 6, the handle 30 abuts against the first end 66 of the pin chamber 27 and is attached to the pin 42 at a first end 99 thereof, with the handle 30 extending in generally orthogonal relation to the pin chamber 27 and the pin 42 extending therethrough. The pin 42 is generally cylindrical and extends from the first end 99 along a longitudinal axis extending through the pin chamber 27 to a second end 102. With reference to FIG. 3, a notch 105 is cut into or formed in a longitudinal section of the pin 42, with the notch 105 forming a contact surface 106 which is recessed into the pin 42 and extends between first and second edges 108 and 111. The longitudinal section of the pin 42 in which the contact surface 106 is formed corresponds to the position of the cut-out 78 formed in the pin chamber 27, such the first edge 108 or second edge 111 may advance through the cut-out 78 to extend below the ball receiver 21. In the embodiment shown, the contact surface 106 is generally polygonal and may be referred to herein as a flat 106.

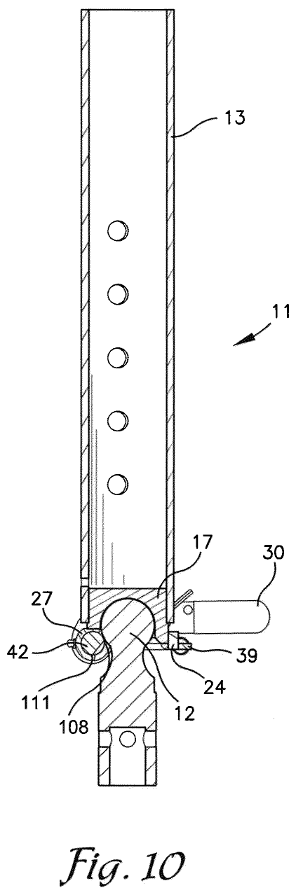

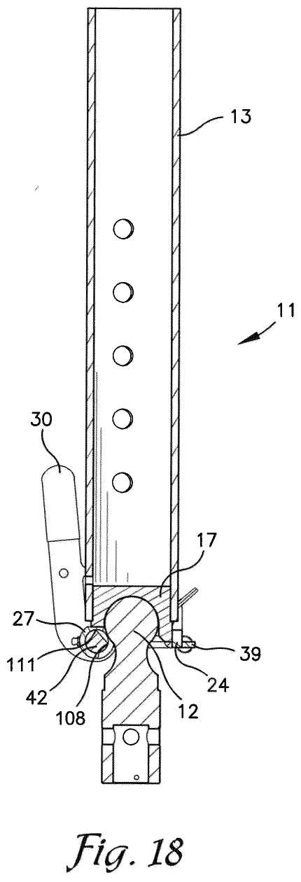

As the lever 30 pivots between the first or latched position and the second or unlatched position, the pin 42 correspondingly or concomitantly rotates within the pin chamber 27 such that the first edge 108 of the flat 106 extends below the ball receiver 21 when the lever 30 is in the first or latched position (see FIGS. 3 and 10) and the second edge 111 of the flat 106 extends below the ball receiver 21 when the lever 30 is in the second or unlatched position (see FIG. 18). As the lever 30 pivots from the latched position to the unlatched position, the pin 42 rotates concomitantly such that the first edge 108 recedes outwardly through the cut-out 78 and into the pin chamber 27 and the second edge 111 advances inwardly through the cut-out 78 to extend below the ball receiver 21. As the lever 30 pivots from the unlatched position to the latched position, the pin 42 rotates concomitantly such that the second edge 111 recedes outwardly through the cut-out 78 and into the pin chamber 27 and the first edge 108 advances inwardly through the cut-out 78 to extend below the ball receiver 21.

Referring to FIG. 2, the bracket 36 abuts against the second end 69 of the pin chamber 27 and is attached to the second end 102 of the pin 42 such that pivoting of the lever 30 between the first or latched position and the second or unlatched position causes corresponding or concomitant pivoting of the bracket 36. The bracket 36 is generally L-shaped and includes a tapering elongate portion 114 which extends away from the second end 69 of the pin chamber 27 and a truncated portion or leg 117, with the leg 117 including a first connection feature 120 which may be referred to herein as a first connection feature 120 and is configured to receive a first end of the extension spring 33. a first spring hole 120 formed therein. The leg 117 extends outward away from the distal or tapered end of the elongate portion 114, such that the first connection feature 120 is spaced radially outward in relation to the axis of rotation in which the pin 42 extends. When the lever 30 is pivoted to the latched position, the elongate portion 114 extends upward in approximately parallel relation to the longitudinal axis of the shank 13, and when the lever 30 is pivoted to the unlatched position the elongate portion 114 extends outward in approximately transverse relation to the longitudinal axis of the shank 13.

As best shown in FIG. 6, the generally elongate anchor plate 39 is fixed to and projects outward from the housing flange 24 and includes an intermediate crescent portion 123 extending between a lever support 126 and a lobe portion 129. The crescent portion 123, lever support 126, and lobe portion 129 are integrally formed in the embodiment shown and it is understood that the crescent portion 123, lever support 126, and lobe portion 129 may be welded, fastened, or otherwise attached or secured to each other without departing from the scope of embodiments of the invention described herein. The crescent portion 123 extends radially from a first periphery 132 to a second periphery 135, with the first periphery 132 oriented proximate the lobe portion 129 and the second periphery 135 oriented proximate the lever support 126. As best shown in FIGS. 5 and 6, the lever support 126 includes a first portion 138 extending outward away from the second periphery 135 and a second portion 141 extending upward from the outer end of the first portion 138 such that the lever support 126 is substantially L-shaped. A lock pin hole 144 is formed in the second portion 141 and a gap 147 is formed in the lever support 126 proximate the juncture of the first and second portions 138 and 141. In the embodiment shown and as best seen in FIG. 5, a tag 150 extends outward from the first portion 138 of the lever support 126 and into the gap 147. When the lever 30 is pivoted to the first position as shown in FIG. 5, the second portion 141 of the lever support 126 extends outward of the lever 30 and the lock pin hole 89 of the lever 30 is coaxially aligned with the lock pin hole 144 of the second member 141. In the embodiment shown, coaxial alignment of the lock pin hole 89 and the lock pin hole 144 is facilitated by abutment of the nub 90 of the lever 30 against the tag 150 of the lever support 126, and a lock pin 153 is provided for selective insertion through the coaxially aligned lock pin holes 89 and 144 to lockably secure the lever 30 in the first position.

Referring to FIG. 6, the lobe portion 129 of the anchor plate 39 extends outward away from the first periphery 132 and includes a second connection feature 156 which may be referred to herein as a second connection feature 156 and is configured to receive a second end of the extension spring 33. In the embodiment shown, the second connection feature 156 and the axis of rotation of the pin 42 extend in a common plane extending transverse to the adapter 11. The bracket 36 and the anchor plate 39 are linked or interconnected by the biasing element 33, which in the embodiment shown is an extension spring 33 extending between the first and second connection 120 and 156 such that the extension spring 33 achieves an over-center condition relative to the longitudinally extending axis about which the pin 42 rotates and biases the latch mechanism 15 toward either the latched orientation or unlatched orientation as the lever 30 is pivoted between the first position and the second position. When the latch mechanism 15 is biasingly urged toward the latched orientation (see FIGS. 7-10), the lever 30 is pivoted to the first position, the pin 42 is rotated with the first edge 108 of the pin flat 106 advancing through the cut-out 78 and extending below the ball receiver 21, and the bracket 36 extends upward in approximately parallel relation to the shank 13 such that first connection feature 120 extends above the axis of rotation about which the pin 42 rotates, and the extension spring 33 extending between the first and second connection features 120 and 156 extends along an axis oriented above the axis of rotation about which the pin 42 rotates. When the latch mechanism 15 is biasingly urged toward the unlatched orientation (see FIGS. 15-18), the lever 30 is pivoted to the second position, the pin 42 is rotated with the second edge 111 of the pin flat 106 advancing through the cut-out 78 and extending below the ball receiver 21, and the bracket 36 extends outward in approximately transverse relation to the shank 13 such that the first connection feature 120 extends below the axis of rotation about which the pin 42 rotates, and the extension spring 33 extending between the first and second connection features 120 and 156 extends along an axis oriented slightly below the axis of rotation about which the pin 42 rotates.

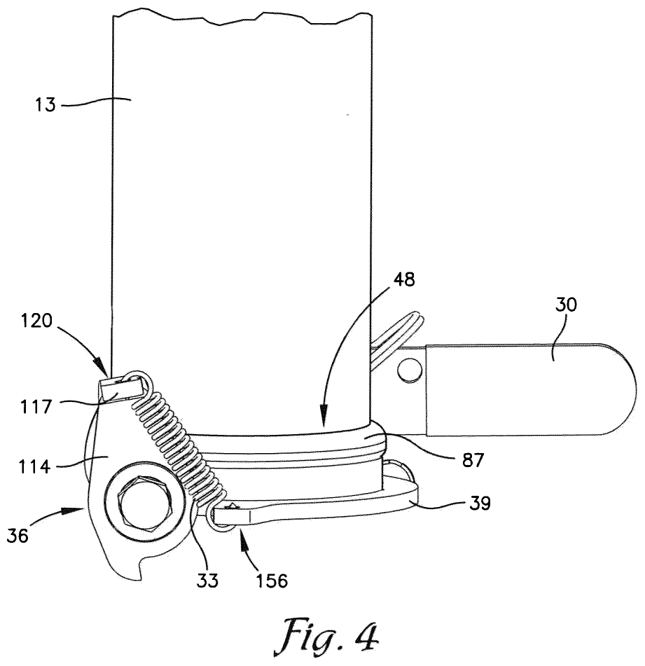

Operation of the coupler 11 is now described in accordance with an embodiment of the invention with the neck 13 of the coupler 11 mounted to the tongue of a trailer. As best seen in FIGS. 3 and 4, with the coupler 11 decoupled from the hitch ball 12 and the latch mechanism 15 in the latched or released orientation the extension spring 33 extends above the axis of rotation of the pin 42 to bias the lever 30 to the first position such that the rod 42 is rotated with the first edge 108 of the flat 106 advancing through the cut-out 78 and extending below the ball receiver 21. The lock pin 153 may be removed from the lock pin holes 89 and 144 formed in the lever 30 and the lever support 126, respectively, to enable the lever 30 to move out of the first position.

The trailer and/or the towing vehicle are positioned such that the housing of the coupler 11 is oriented above the head of the hitch ball 12, at which point the trailer is lowered and the ball receiver 21 formed in the housing 17 approaches the head of the hitch ball 12.

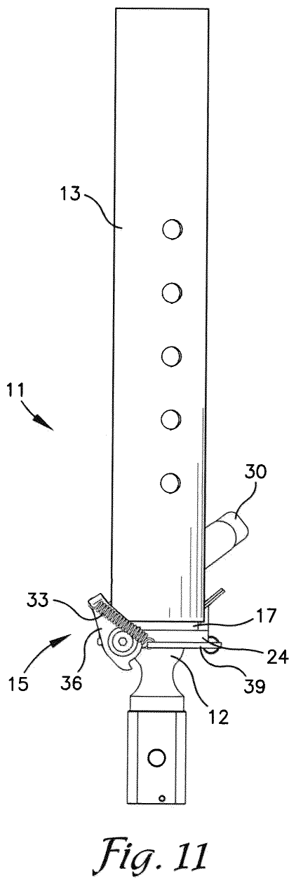

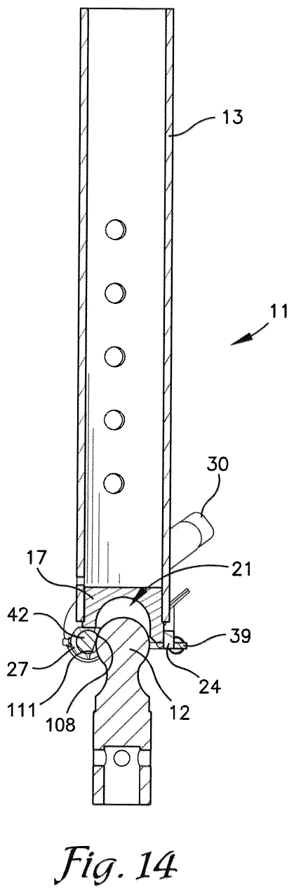

With reference to FIGS. 14 and 18, to couple the coupler 11 to the hitch ball 12, the coupler 11 is lowered toward the hitch ball 12 until the head of the hitch ball 12 enters the ball receiver 21 and gradually engages the flat 106, forcing the rod 42 to rotate such that the first edge 108 of the flat 106 recedes outward through the cut-out 78 and into the pin chamber 27 and the second edge 111 of the flat 106 advances inward through the cut-out 78 to contact the head of the hitch ball 12 at a point below the equator thereof. As the rod 42 rotates, the bracket 36 pivots outward relative to the anchor plate 39 (see FIGS. 11-14) such that the extension spring 33 is urged downward toward the axis of rotation of the rod 42, with the force exerted by the head of the hitch ball 12 onto the rod 42 overcoming the bias of the extension spring 33 and pivoting the lever 30 from the first position toward the second position.

As the coupler 11 is lowered further onto the hitch ball 12, the equator of the head of the hitch ball 12 gradually disengages from the flat 106 until the extension spring 33 biases the rod 42 to rotate such that the second edge 111 of the flat 106 recedes outward through the cut-out 78 and into the pin chamber 27 and the first edge 108 advances inward through the cut-out 78 to a position below the equator of the head of the hitch ball 12 (see. FIG. 18). Once the equator of the head of the hitch ball 12 advances upward past the first edge 108 of the flat 106 of the rod 42, and before the spring 33 advances to an over centered position relative to the axis of the rod 42, the spring 33 pulls or draws the bracket 36 back upward relative to the anchor plate 39, urging the rod 42 to rotate back to a position as generally shown in FIG. 10, such that the circumferential surface or edge of the rod 42, spaced away from the rod flat 106, extends under the equator of the head of the hitch ball 12. As the bracket 36 pivots upward relative to the anchor plate 39, the latch 30 connected to the opposite end of the rod 42 pivots downward until the latch mechanism 15 is in the latched orientation with the head of the hitch ball 12 encapsulated within the ball receiver 12 and the coupler 11 coupled to the hitch ball 12 as shown in FIGS. 7-10. With the latch mechanism 15 so oriented, the circumferential edge of the rod 42 obstructs movement of the head of the hitch ball 12 to prevent withdrawal of the hitch ball 12 from the ball receiver 21. In an embodiment, the lock pin 153 may be inserted through the lock pin holes 89 and 144 formed in the lever 30 and the lever support 126, respectively, to lockably secure the lever 30 in the first position. Because the coupler 11 automatically couples to the hitch ball 12 when lowered thereupon, it can fairly be said to be “self-latching.”

To decouple the coupler 11 from the hitch ball 12, the lever 30 is pivoted from the first position, as shown in FIG. 10, to the second position, as shown in FIG. 18, to rotate the pin 42 such that the first edge 108 of the flat 106 recedes outward through the cut-out 78 and into the pin chamber 27 and the second edge 111 of the flat 106 advances inward through the cut-out 78 to a position just below the head of the hitch ball 12 as best shown in FIG. 18. As the rod 42 rotates, the bracket 36 pivots to extend outward away from the anchor plate 39 and in approximately transverse relation to the longitudinal axis of the shank 13 (see FIG. 15), urging the extension spring 33 downward to extend slightly below the axis of rotation of the rod 42 to biasingly hold the latch mechanism 15 in the unlatched orientation. With the latch mechanism 15 so oriented, the coupler 11 is raised off the hitch ball 12 with the head of the hitch ball 12 gradually engaging the flat 106 and forcing the rod 42 to rotate such that the second edge 111 of the flat 106 recedes outward through the cut-out 78 and into the pin chamber 27 and the first edge 108 of the flat 106 advances inward through the cut-out 78 to a position above the equator of the head of the hitch ball 12 (see FIG. 14). As the rod 42 rotates, the bracket 36 correspondingly pivots upward such that an axis of the extension spring 33 extends above the axis of rotation of the rod 42 (see FIG. 11). As the head of the hitch ball 12 is further withdrawn from the ball receiver 21, the spring 33 biases the rod 42 to continue to rotate until the first edge 108 of the flat 106 extends below the ball receiver 21 and the lever 30 pivots to the first position. Because the latch mechanism 15 of the coupler 11 automatically reverts to the released orientation (which is the same as the latched orientation but without the hitch ball head in the ball receiver 21) when the coupler 11 is decoupled from the hitch ball 12, the coupler 11 can be said to be “auto-resetting” as well as “self-latching.”

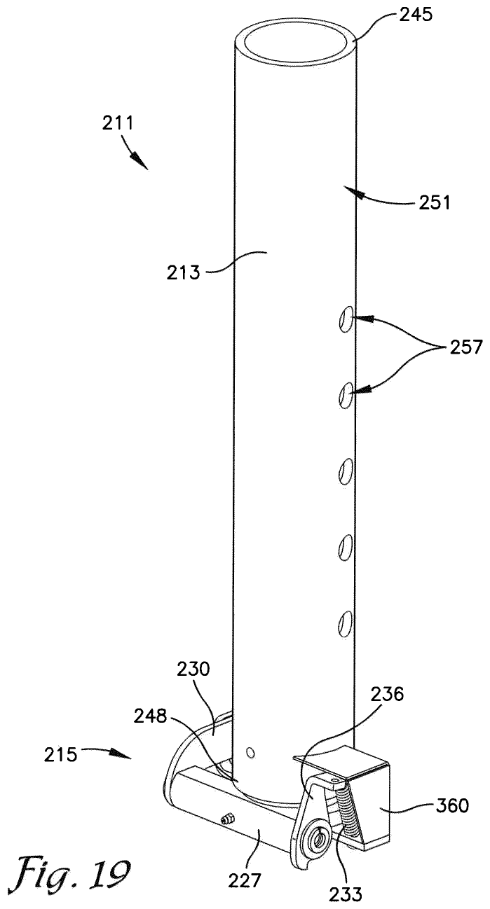

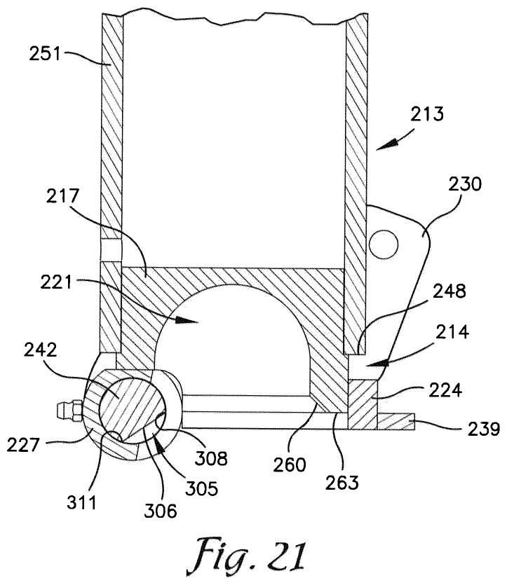

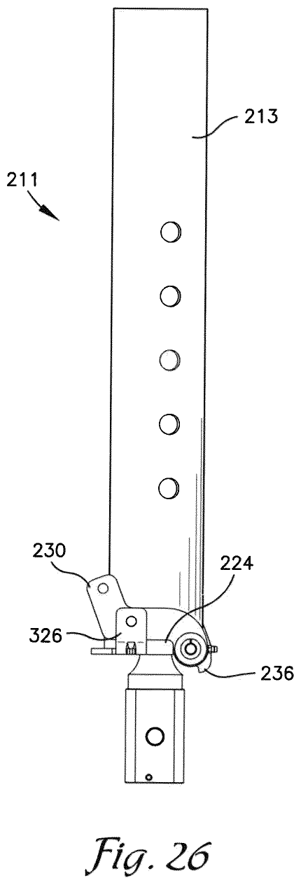

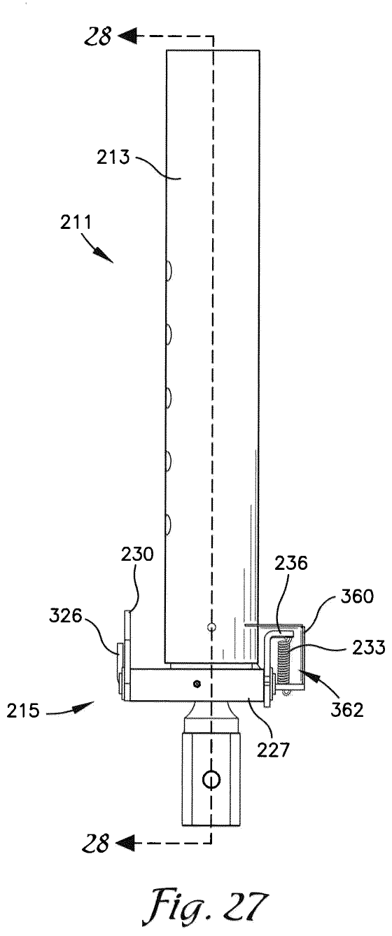

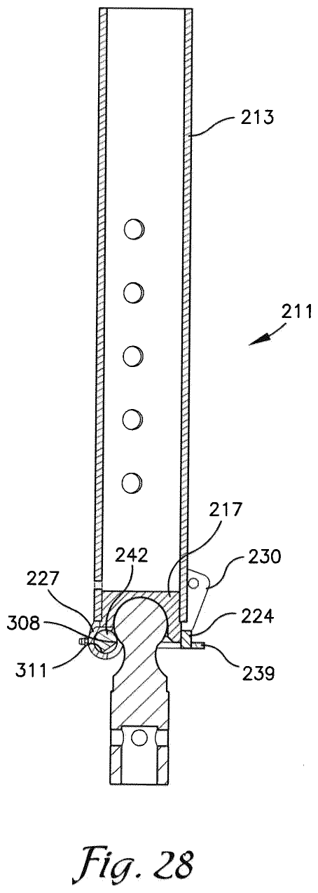

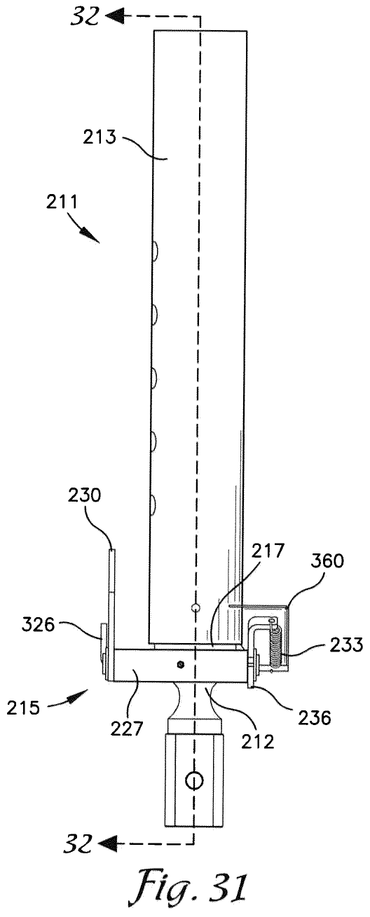

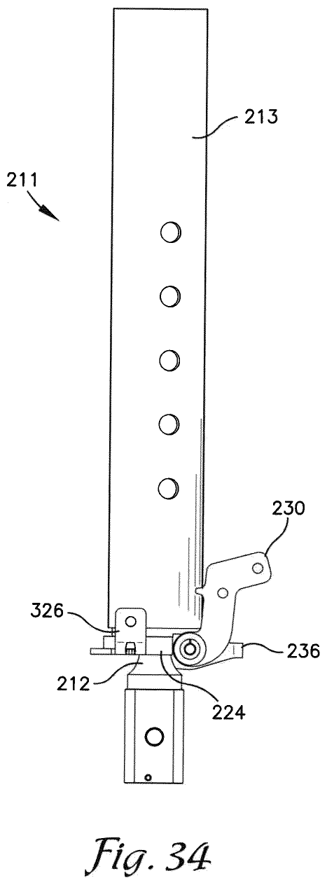

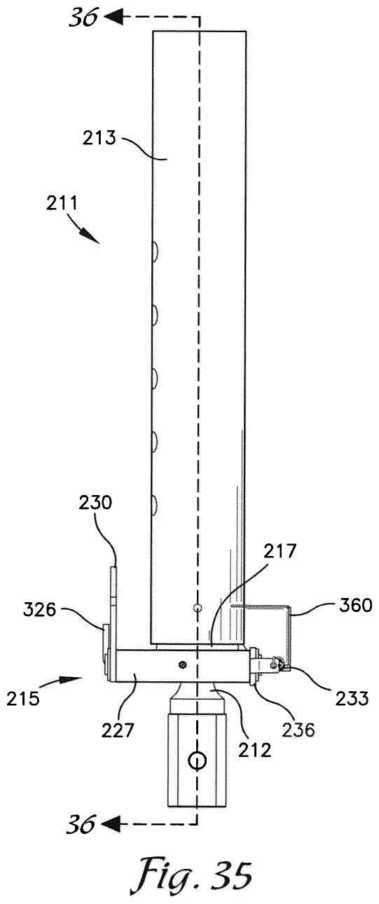

FIGS. 19-36 depict a first alternative embodiment of the self-latching auto-resetting trailer coupler, which is denominated herein as coupler 211. Like the coupler 11, the coupler 211 is adapted to couple to a hitch ball 212 and includes a trailer-mountable shank 213 with a housing 214 joined to an end thereof and an adjustable latch mechanism 215 which engages the head of the hitch ball 212 and is adjustable between a latched orientation (which may also be referred to herein as a released orientation) and an unlatched orientation. The housing 214 and the latch mechanism 215 generally include the same features as the housing 14 and the latch mechanism 15 described above, and are configured in a similar manner. As best seen in FIG. 21, the housing 214 includes a receiver body 217 having a ball receiver 221 formed therein and to which a flange 224 and a pin chamber 227 are secured. The latch mechanism 215 includes a lever 230 and a biasing element or extension spring 233 operable for biasingly holding the latch mechanism 215 in the latched orientation or the unlatched orientation, with the lever 230 extending proximate one end of the pin chamber 227 and the biasing element 233 extending proximate the other end of the pin chamber 227 and between a bracket 236 and an anchor plate 239. A pin 242 extends through the pin chamber 227, with the lever 230 and the bracket 236 attached to opposite ends of the pin 242.

The shank 213 extends from an upper end 245 to a lower end 248 and includes a cylindrical wall 251 with a space formed therein. The shank 213 includes one or more alignment features 257 which are alignable with corresponding features formed on the tongue of a trailer to mount the coupler 211 thereto. In the embodiment shown and as best seen in FIG. 19, the alignment features 257 are a plurality of holes 257 formed in the cylindrical wall 251 along the length of the shank 213. The receiver body 217 of the housing 214 is joined to the lower end 248 of the shank 213, with the ball receiver 221 formed in the receiver body 217 facing downward to receive the head of the hitch ball 212 as the coupler 211 is lowered onto the hitch ball 212. A chamfer 260 which is configured to guide the head of the hitch ball 212 into the ball receiver 221 partially circumscribes the ball receiver 221 and extends outward and downward from the ball receiver 221 to a lip 263 formed on the receiver body 217.

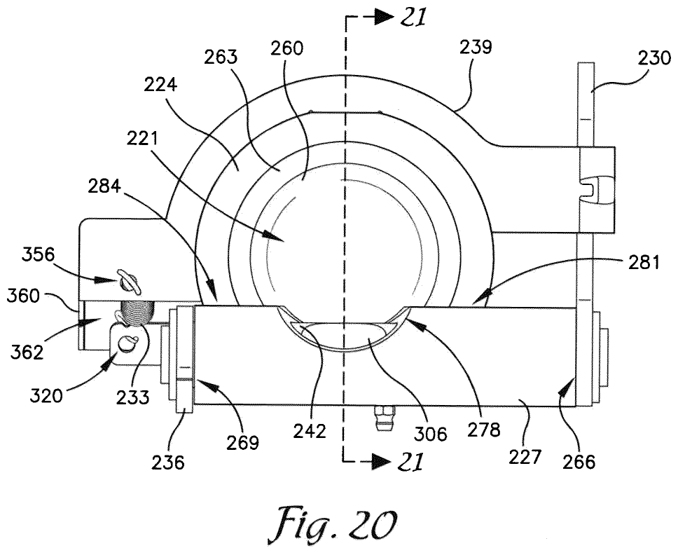

A generally annular pin chamber 227 intersects the receiver body 217 and the ball receiver 221, extending longitudinally from a lever end 266 to a spring end 269 on an axis extending transverse to the shank 213. The pin chamber 227 is outwardly offset from the longitudinal axis along which the shank 213 extends and is positioned such that a portion of the pin chamber 227 extends below the ball receiver 221. As best shown in FIG. 20, a cut-out 278 is formed in the portion of the pin chamber 227 that extends below the ball receiver 221, such that the hitch ball 212 traverses the cut-out 278 as the coupler 211 is lowered onto or raised off of the hitch ball 212 and the pin chamber 227 does not obstruct the head of the hitch ball 212 from moving into or out of the ball receiver 221.

Referring to FIGS. 20 and 21, the flange 224 of the housing 214 extends below the lower end 248 of the shank 213 along an outer portion of the receiver body 217 between first and second ends 281 and 284 which abut against the pin chamber 227. In an embodiment, the housing 214 may be joined to the shank 213 by a first and second welds or bonds (not shown), with the first weld extending along the lower end 248 of the shank 213 to secure the flange 224 and the pin chamber 227 to the lower end 248 and the second weld extending radially outward and downward of the chamfer 260 to secure the flange 224 to the lip 263 of the receiver body 217 and guide the head of the hitch ball 212 toward the chamfer 260 and into the ball receiver 221 and the coupler 211 is lowered onto the hitch ball 212. It should be understood that the housing 214 including the receiver body 217 may be integrally formed with the shank 213 and such components integrally formed together may be deemed to be connected or joined together.

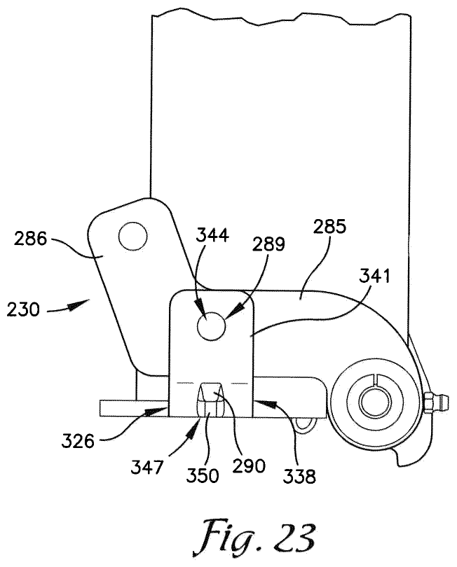

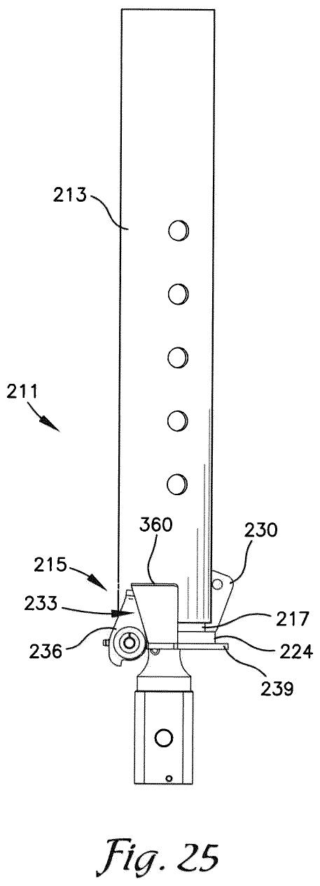

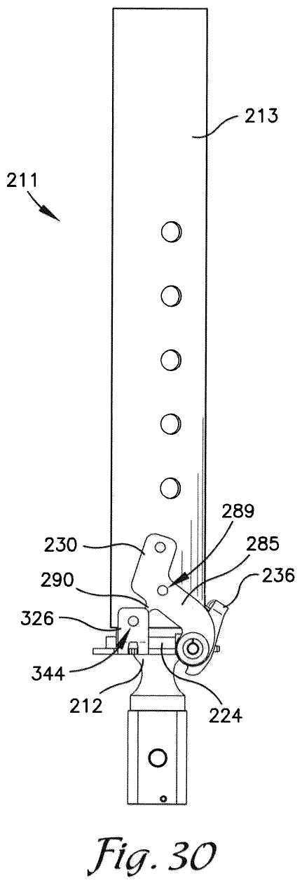

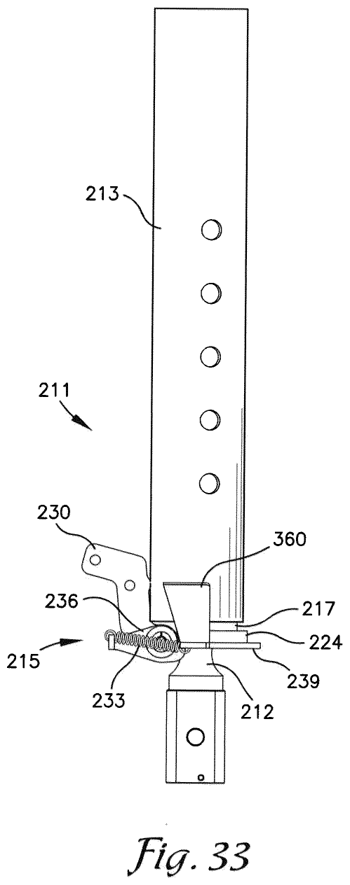

The lever 230 of the latch mechanism 215 is an elongate member which abuts against the lever end 266 of the pin chamber 227 and is attached to the pin 242. Referring to the orientation shown in FIG. 23, the lever 230 turns outward and extends away from the lever end 266 of the pin chamber 227 to form a central portion 285 before turning upward and extending further outward to form an end wing 286 to which a grip (not shown) may be secured. Like the lever 30 of the latch mechanism 15, the lever 230 of the latch mechanism 215 is pivotable between a first or latched position (see FIGS. 25-28) wherein the central portion 285 of the lever 230 extends in a plane extending approximately transverse to the longitudinal axis of the shank 213 and approximately parallel to the truck bed of the towing vehicle (not shown) and a second or unlatched position (see FIGS. 33-36) wherein the central portion 285 of the lever 230 extends in a plane extending approximately parallel to the longitudinal axis of the shank 213 and approximately transverse to the truck bed of the towing vehicle. As best shown in FIG. 30, a lock pin hole 289 is formed in the central portion 285 of the lever 230 and a nub 290 protrudes from a lower edge of the central portion 285 such that the nub 290 extends downward when the lever 230 is pivoted to the first position.

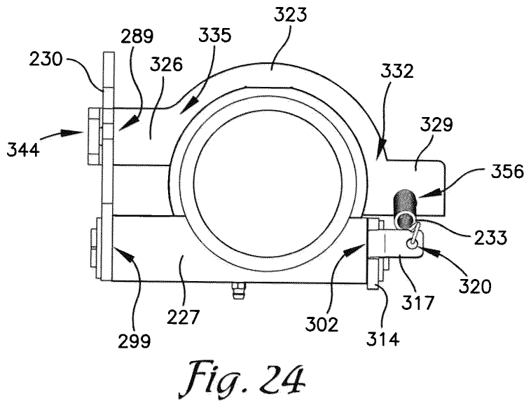

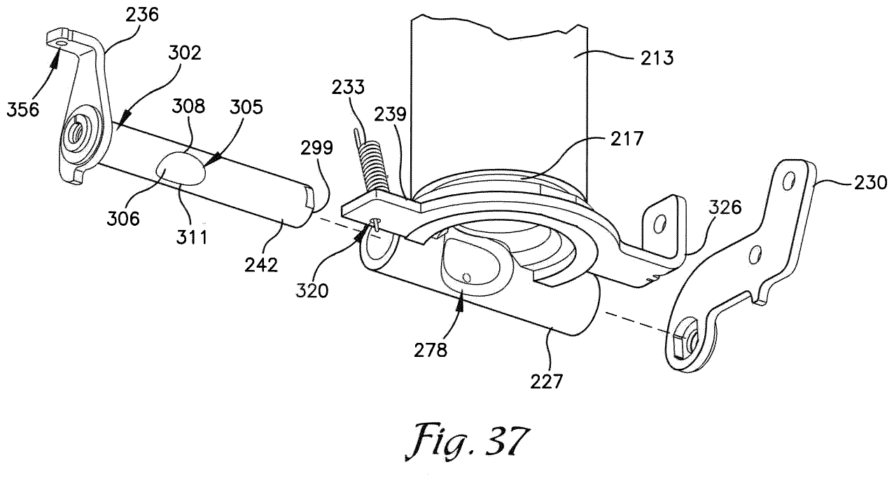

Referring to FIG. 24, the lever 230 is attached to a first end 299 of the pin 242, with the pin 242 extending away from the lever 230 in generally orthogonal relation thereto. The pin 242 is generally cylindrical and extends from the first end 299 along a longitudinal axis extending through the pin chamber 227 to a second end 302, with the first end 299 extending proximate the lever end 266 of the pin chamber 227 and the second end 302 extending proximate the spring end 269 of the pin chamber 227. A notch 305 is formed in a central, longitudinal section of the pin 242, with the notch 305 forming a contact surface 306 which is recessed into the pin 242 and extends between first and second edges 308 and 311 (see FIGS. 21 and 37). The longitudinal section of the pin 242 in which the contact surface 306 is formed corresponds to the position of the cut-out 278 formed in the pin chamber 227, such that the first or second edges 308 or 311 may advance through the cut-out 278 to extend below the ball receiver 221. In the embodiment shown, the contact surface 306 comprises a curved or generally elliptical profile, with the curvature of the contact surface 306 corresponding to the curvature of the head of the hitch ball 212 proximate the equator thereof. The contact surface 306 may be referred to herein as a recessed face 306. Pivoting the lever 230 between the first or latched position and the second or unlatched position correspondingly or concomitantly rotates the pin 242 within the pin chamber 227, such that when the lever 230 is in the latched position the first edge 308 of the recessed face 306 extends below the ball receiver 221 and when the lever 230 is in the unlatched position the second edge 311 of the recessed face 306 extends below the ball receiver 221.

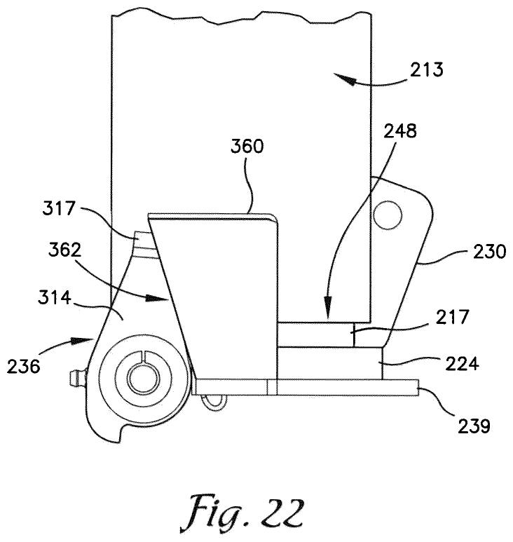

As best shown in FIGS. 19 and 22, the bracket 236 is generally L-shaped with a tapered elongate portion 314 extending away from the spring end 269 of the pin chamber 227 and a truncated portion or leg 317 extending outward from the tapered end of the elongate portion 314. A first spring hole 320 is formed in the truncated portion 317 of the bracket 236. The bracket 236 abuts against the spring end 269 of the pin chamber 227 and is attached to the second end 302 of the pin 242 such that pivoting of the lever 230 between the first or latched position and the second or unlatched position correspondingly or concomitantly pivots the bracket 236, with the elongate portion 314 of the bracket 236 extending upward in approximately parallel relation to the shank 213 when the lever 230 is pivoted to the first position and the elongate portion 314 of the bracket 236 extending outward in approximately transverse relation to the shank 213 when the lever 230 is pivoted to the second position.

As best shown in FIG. 24, the anchor plate 239 adjoins the outer edge of the flange 224 and includes an intermediate crescent portion 323 extending between a lever support 326 and a lobe portion 329. The crescent portion 323 extends between first and second peripheries 332 and 335, with the first periphery oriented proximate the lobe portion 329 and the second periphery 332 oriented proximate the lever support 326. The lever support 326 is generally L-shaped with a first portion 338 extending outward from the second periphery 335 of the crescent portion 323 and a second portion 341 extending upward from the outer end of the first portion 338. A lock pin hole 344 is formed in the second portion 341 and a gap 347 is formed proximate the juncture of the first and second portions 338 and 341. A tag 350 extends outward from the first portion 338 and into the gap 347. When the lever 230 is pivoted to the first position, the nub 290 of the lever 230 abuts against the tag 350 of the lever support 326 and the lock pin hole 289 formed in the lever 230 extends coaxial with the lock pin hole 344 formed in the lever support 326. It is understood that a lock pin (not shown) may be provided for insertion through the lock pin holes 289 and 344 to lockably secure the lever 230 in the first position.

Referring still to FIG. 24, the lobe portion 329 of the anchor plate 239 extends outward from the first periphery 332 of the crescent portion 323 and has a second spring hole 356 formed therein. The extension spring 233 extends between the first and second spring holes 320 and 356, linking the bracket 236 to the anchor plate 239 such that the extension spring 233 achieves an over-center condition relative to the axis of rotation of the pin 242. The extension spring 233 biases the latch mechanism 215 toward either the latched orientation (which also comprises a released orientation) or the unlatched orientation as the lever 230 is pivoted between the first position and the second position. A shroud 360 extends upward from the outer edge of the lobe portion 329 of the anchor plate 239 and the edge of the lobe portion 329 opposite the bracket 236, before turning inward to abut against the shank 213 such that the shroud 360 extends outward of and above the extension spring 233 to protect the extension spring 233 from external forces that may break or damage the extension spring 233 or may disconnect one or both ends of the extension spring 233 from their respective first and second spring holes 320 and 356. The shroud 360 includes an opening 362 sized to allow passage of the extension spring 233 and the bracket 236 therethrough, allowing the pivoting of the bracket 236 and corresponding adjustment of the extension spring 233 as the lever 230 is pivoted between the first position and the second position. In the embodiment shown, when the lever 230 is pivoted to the first position the entire extension spring 233 extends below and inward of the shroud 360 (see FIG. 25), and when the lever 230 is pivoted to the second position a portion of the extension spring 233 proximate the second spring hole 356 extends below and inward of the shroud 360 and a portion of the extension spring 233 proximate the first spring hole 320 extends outward of the shroud 360 and is unprotected thereby (see FIG. 33). In the embodiment shown, the shroud 360 is a bent or folded plate 360. It should be understood that the shroud 360 may comprise other geometries and may protect the extension spring 233 in manners other than those of the embodiment shown without departing from the scope of embodiments of the invention described herein.

When the latch mechanism 215 is biased toward latched orientation (see FIGS. 25-28), the lever 230 is pivoted to the first position, the pin 242 is rotated with the first edge 308 of the recessed face 306 extending below the ball receiver 221, and the bracket 236 extending upward in approximately parallel relation to the shank 213 such that the extension spring 233 extends along an axis oriented above the axis of rotation of the pin 42. When the latch mechanism 215 is advanced to the unlatched orientation (see FIGS. 33-36), the lever 230 is pivoted to the second position, the pin 42 is rotated with the second edge 311 of the recessed face 306 extending below the ball receiver 221, and the bracket 236 extending outward in approximately transverse relation to the shank 213 such that the extension spring 233 extends along an axis oriented slightly below the axis of rotation of the pin 242.

Operation of the coupler 211 is now described in accordance with an embodiment of the invention. With the shank 213 mounted to the tongue of a trailer and the coupler 211 decoupled from the hitch ball 212, the latch mechanism 215 positioned or advanced to the released orientation wherein the extension spring 233 extends above the axis of rotation of the pin 242 to bias the lever 230 to the first position such that the pin 242 is rotated with the first edge 308 of the recessed face 306 advancing through the cut-out 278 and extending below the ball receiver 221. The trailer and/or the towing vehicle are positioned such that the housing of the coupler 211 is oriented above the head of the hitch ball 212, at which point the trailer is lowered and the ball receiver 221 formed in the receiver body 217 approaches the head of the hitch ball 212.

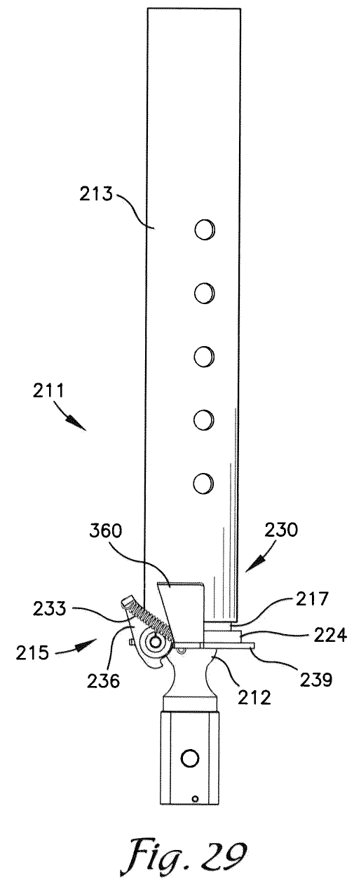

To couple the coupler 211 to the hitch ball 212, the coupler 211 is lowered toward the hitch ball 212 until the head of the hitch ball 212 enters the ball receiver 221 and gradually engages the recessed face 306, forcing the pin 242 to rotate such that the first edge 308 of the recessed face 306 recedes outward through the cut-out 278 and into the pin chamber 227 and the second edge 311 of the recessed face 306 advances inward through the cut-out 278 to contact the head of the hitch ball 212 at a point below the equator thereof. As the pin 242 rotates, the bracket 236 pivots outward relative to the anchor plate 239 (see FIGS. 29-32) such that the extension spring 233 is urged downward toward the axis of rotation of the pin 242, with the force exerted by the head of the hitch ball 212 onto the pin 242 overcoming the bias of the extension spring 233 and pivoting the lever 230 from the first position toward the second position.

As the coupler 211 is lowered further onto the hitch ball 212, the equator of the head of the hitch ball 212 gradually disengages from the recessed face 306 until the extension spring 233 biasingly draws the bracket 236 back upward causing the pin 242 to continue to rotate such that the second edge 311 of the recessed face 306 recedes outward through the cut-out 278 and into the pin chamber 227 and the first edge 308 advances inward through the cut-out 278 to a position below the equator of the head of the hitch ball 212. As the pin 242 rotates, the bracket 236 pivots upward relative to the anchor plate 239 such that the extension spring 233 is urged upward away from the axis of rotation of the pin 242, with the extension spring 233 biasing the lever 230 to pivot back toward the first position until the latch mechanism 215 is in the latched orientation with the head of the hitch ball 212 encapsulated within the ball receiver 212 and the coupler 211 coupled to the hitch ball 212 as shown in FIGS. 25-28. With the latch mechanism 215 so oriented, the circumferential surface of the pin 242 extending circumferentially between the first edge 308 and second edge 311 of the recessed face 306 obstructs movement of the head of the hitch ball 212 such that the head of the hitch ball 212 is retained within the ball receiver 221. Because the coupler 211 automatically couples to the hitch ball 212 when lowered thereupon, it can fairly be said to be “self-latching.”

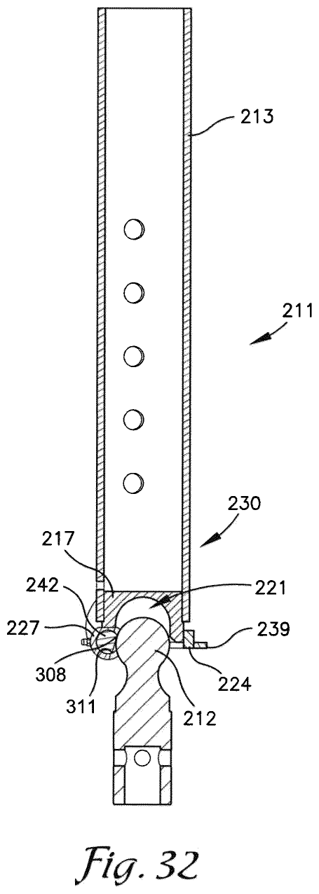

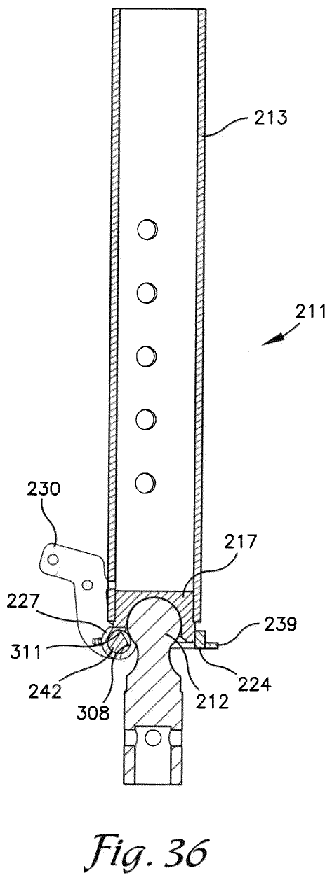

To decouple the coupler 211 from the hitch ball 212, the lever 230 is pivoted from the first position to the second position to rotate the pin 242 such that the first edge 308 of the recessed face 306 recedes outward through the cut-out 278 and into the pin chamber 227 and the second edge 311 of the recessed face 306 advances inward through the cut-out 278 to a position just below the head of the hitch ball 212 as shown in FIG. 36. As the pin 242 rotates, the bracket 236 pivots to extend outward away from the anchor plate 239 and in approximately transverse relation to the shank 213, urging the extension spring 233 downward to extend slightly below the axis of rotation of the pin 242 and bias the latch mechanism 215 to the unlatched orientation. With the latch mechanism 215 so oriented, the coupler 211 is raised off the hitch ball 212 with the head of the hitch ball 212 gradually engaging the recessed face 306 and forcing the pin 242 to rotate such that the second edge 311 of the recessed face 306 recedes outward through the cut-out 278 and into the pin chamber 227 and the first edge 308 of the recessed face 306 advances inward through the cut-out 278 to a position above the equator of the head of the hitch ball 212 (see FIG. 32). As the pin 242 rotates, the bracket 236 correspondingly pivots upward such that the extension spring 233 extends above the axis of rotation of the pin 242 and biases the pin 242 to rotate until the first edge 308 of the recessed face 306 extends below the ball receiver 221 and the lever 230 pivots to the first position. Because the latch mechanism 215 of the coupler 211 automatically reverts to the released orientation when the coupler 211 is decoupled from the hitch ball 212, the coupler 211 can be said to be “auto-resetting” as well as “self-latching.”

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure is intended to demarcate those structures as including a plurality of possible arrangements or designs within the scope of this disclosure and readily identifiable by one of skill in the art to perform the particular function in a similar way without specifically listing all such arrangements or designs. Certain features and sub-combinations are of utility and may be employed without reference to other features and sub-combinations and are contemplated within the scope of the claims.

What is claimed is:

1. A coupler for connecting a trailer to a hitch ball, the coupler comprising:
a housing having a ball receiver for receiving a head of the hitch ball;
a pin extending in an axis of rotation transverse to a vertical axis of the ball receiver, the pin rotatable between a latched orientation and an unlatched orientation and extendable below the ball receiver, the pin having a contact surface longitudinally oriented thereon, the contact surface having a first edge and a second edge;
a lever projecting from the pin, the lever pivotable between a first position and a second position; and
an extension spring linked to the pin; wherein:
when the pin is rotated to the latched orientation, the extension spring biases the lever to the first position and the first edge of the contact surface extends below the ball receiver;
and when the pin is rotated to the unlatched orientation, the extension spring biases the lever to the second position and the second edge of the contact surface extends below the ball receiver.

2. The coupler as in claim 1, wherein when the head of the hitch ball is received within the ball receiver, and the pin is in the latched orientation, the pin obstructs the head of the hitch ball below an equator of the head of the hitch ball preventing withdrawal of the head of the hitch ball from the ball receiver.

3. The coupler as in claim 1, wherein, when the pin is in the latched orientation, engagement of the head of the hitch ball with the first edge of the contact surface of the pin, upon advancement of the head of the hitch ball into the ball receiver, rotates the pin from the latched orientation toward the unlatched orientation.

4. The coupler as in claim 1, wherein pivoting of the lever from the first position to the second position rotates the pin from the latched orientation to the unlatched orientation.

5. The coupler as in claim 1, wherein, when the pin is in the unlatched orientation, engagement of the head of the hitch ball with the second edge of the contact surface of the pin upon withdrawal of the hitch ball from the ball receiver rotates the pin from the unlatched orientation toward the latched orientation.

6. The coupler as in claim 1, wherein the housing includes a chamfer surrounding the ball receiver.

7. The coupler as in claim 1, wherein the lever is lockably securable in the first position.

8. The coupler as in claim 1, wherein the housing includes a chamber through which the pin extends, the chamber having a cut-out formed therein, the orientation of the cut-out corresponding to the head of the hitch ball.

9. The coupler as in claim 1, wherein the housing is welded to an end of a shank.

10. A coupler for connecting a trailer to a hitch ball, the coupler comprising:
a shank;
a housing joined to an end of the shank and having a ball receiver for receiving a head of the hitch ball;
a rotatable pin extending along an axis of rotation transverse to a longitudinal axis of the shank, the rotatable pin extendable below the ball receiver and engageable with the head of the hitch ball;
a lever attached to the rotatable pin, the lever pivotable between a first position and a second position;
a bracket connected to and rotatable in correspondence with the rotatable pin; and
an extension spring connected at a first end thereof to the bracket and connected at a second end thereof to an anchor plate, the extension spring achieving an over-center condition relative to the rotatable pin; wherein:
the first end of the extension spring extends above the axis of rotation of the rotatable pin when the lever is pivoted to the first position; and
the first end of the extension spring extends below the axis of rotation of the rotatable pin when the lever is pivoted to the second position.

11. The coupler as in claim 10, wherein the housing includes an annular chamber through which the rotatable pin extends, the annular chamber having a cut-out, the cut-out having a curvature corresponding to a curvature of an equator of the head of the hitch ball.

12. The coupler as in claim 11, wherein the rotatable pin has a contact surface longitudinally oriented thereon, the contact surface having:
a first edge that, when the head of the hitch ball is received within the ball receiver and the lever is pivoted to the first position, advances through the cut-out and extends below an equator of the head of the hitch ball, the rotatable pin thereby preventing withdrawal of the head of the hitch ball from the ball receiver; and
a second edge that, when the head of the hitch ball is received within the ball receiver and the lever is pivoted to the second position, advances through the cut-out and extends below an equator of the head of the hitch ball, the rotatable pin thereby allowing withdrawal of the head of the hitch ball from the ball receiver.

13. The coupler as in claim 10, wherein the housing includes a chamfer surrounding the ball receiver.

14. The coupler as in claim 10, wherein the lever extends approximately transverse to
the longitudinal axis of the shank when the lever is pivoted to the first position, and
the lever extends approximately parallel to the longitudinal axis of the shank when the lever is pivoted to the second position.

15. A coupler for connecting a trailer to a hitch ball, the coupler comprising:
a housing including a receiver body having a ball receiver formed therein, the ball receiver sized to receive a head of the hitch ball;
a pin rotatably supported by the housing and extending in an axis of rotation transverse to a vertical axis of the ball receiver and along a lower edge of the ball receiver, such that the pin is rotatable between a latched orientation and an unlatched orientation, wherein when the head of the hitch ball is received within the ball receiver, advancing the pin to the latched orientation advances a circumferential edge of the pin below an equator of the head of the hitch ball preventing withdrawal of the head of the hitch ball from the ball receiver, and advancing the pin to the unlatched orientation rotates a recessed portion of the pin below the equator of the head of the hitch ball;
a handle projecting from a first end of the pin, the handle advanceable between a first position, wherein the pin is rotated to the latched orientation, and to a second position wherein the pin is rotated to the unlatched orientation;
a bracket projecting from a second end of the pin opposite the handle and configured to rotate in correspondence with the pin, the bracket having a first connection feature thereon positioned in radially outward spaced relationship to the axis of rotation of the pin;
a second connection feature connected to the housing proximate the second end of the pin; and
a biasing element extending between the first connection feature and the second connection feature, the biasing element biasingly urging the bracket to rotate the pin toward the latched orientation when the first connection feature extends above the axis of rotation of the pin, and the biasing element biasingly urging the bracket to rotate the pin toward the unlatched orientation when the first connection feature is oriented below the axis of rotation of the pin.

16. The coupler as in claim 15, wherein the pin is rotatably supported by an annular chamber, the annular chamber extending along the lower edge of the receiver body and having a cut-out formed therein, the cut-out sized to allow advancement of the circumferential edge of the pin therethrough.

17. The coupler as in claim 15, wherein the axis of rotation of the pin and the second connection feature extend in a common plane extending transverse to the vertical axis of the ball receiver.

18. The coupler as in claim 15, wherein the recessed portion of the pin forms a contact surface, the contact surface having a curved profile corresponding to the curvature of the head of the hitch ball proximate the equator thereof.

19. The coupler as in claim 18, wherein, when the pin is rotated to the latched orientation, advancement of the head of the hitch ball into the ball receiver advances the head of the hitch ball into engagement with the contact surface of the pin such that the head of the hitch ball urges the pin to rotate until the first connection feature is oriented below the axis of rotation of the pin, wherein the biasing element biasingly urges the bracket to rotate the pin to the unlatched orientation.

20. The coupler as in claim 18, wherein, when the pin is rotated to the unlatched orientation, withdrawal of the head of the hitch ball from the ball receiver advances the head of the hitch ball into engagement with the contact surface of the pin causing the pin to rotate until the first connection feature is oriented above the axis of rotation of the pin, wherein the biasing element biasingly urges the bracket to rotate the pin to the latched orientation.
